(19) United States
(12) Patent Application Publication
(10) Pub. No.: US 2010/0065785 A1
(43) Pub. Date: Mar. 18, 2010

(54) VOLTAGE SWITCHABLE DIELECTRIC MATERIAL CONTAINING BORON COMPOUND

(76) Inventors: Lex Kosowsky, San Jose, CA (US); Robert Fleming, San Jose, CA (US)

Correspondence Address: MAHAMEDI PARADICE KREISMAN LLP, 550 Winchester Boulevard, Suite 605, SAN JOSE, CA, 95128, US

(21) Appl. No.: 12/561,195

(22) Filed: Sep. 16, 2009

Related U.S. Application Data
(60) Provisional application No. 61/097,852, filed on Sep. 17, 2008.

(51) Int. Cl. C01B 35/14; H01B 1/06

(52) U.S. Cl. 252/500; 423/284; 977/773

(57) ABSTRACT

A composition of voltage switchable dielectric (VSD) material that comprises Boron. According to embodiments, VSD material is formulated that includes particle constituents that include one or more of Boron-nitride polymers, Boron nanotubes, and/or Boron nanoparticles.

### RELATED APPLICATIONS

This application claims benefit of priority to Provisional U.S. Patent Application No. 61/097,852 filed Sep. 17, 2008; the aforementioned priority application being hereby incorporated by reference in its entirety.

### TECHNICAL FIELD

Embodiments described herein pertain generally to voltage switchable dielectric material, and more specifically to voltage switchable dielectric composite materials containing Boron compounds.

### BACKGROUND

Voltage switchable dielectric (VSD) materials are materials that are insulative at low voltages and conductive at higher voltages. These materials are typically composites comprising of conductive, semiconductive, and insulative particles in an insulative polymer matrix. These materials are used for transient protection of electronic devices, most notably electrostatic discharge protection (ESD) and electrical overstress (EOS). Generally, VSD material behaves as a dielectric, unless a characteristic voltage or voltage range is applied, in which case it behaves as a conductor. Various kinds of VSD material exist. Examples of voltage switchable dielectric materials are provided in references such as U.S. Pat. No. 4,977,357, U.S. Pat. No. 5,068,634, U.S. Pat. No. 5,099,380, U.S. Pat. No. 5,142,263, U.S. Pat. No. 5,189,387, U.S. Pat. No. 5,248,517, U.S. Pat. No. 5,807,509, WO 96/02924, and WO 97/26665, all of which are incorporated by reference herein.

VSD materials may be formed in using various processes. One conventional technique provides that a layer of polymer is filled with high levels of metal particles to very near the percolation threshold, typically more than 25% by volume. Semiconductor and/or insulator materials is then added to the mixture.

Another conventional technique provides for forming VSD material by mixing doped metal oxide powders, then sintering the powders to make particles with grain boundaries, and then adding the particles to a polymer matrix to above the percolation threshold.

Other techniques for forming VSD material are described in U.S. patent application Ser. No. 11/829,946, entitled VOLTAGE SWITCHABLE DIELECTRIC MATERIAL HAVING CONDUCTIVE OR SEMI-CONDUCTIVE ORGANIC MATERIAL; and U.S. patent application Ser. No. 11/829,948, entitled VOLTAGE SWITCHABLE DIELECTRIC MATERIAL HAVING HIGH ASPECT RATIO PARTICLES.

### BRIEF DESCRIPTION OF THE DRAWINGS

FIG. 1A illustrates a formulation of VSD material, under an embodiment.

FIG. 1B illustrates examples of BN polymers, as well as their respective carbon based analogs, for inclusion as constituents in a composition of VSD material.

FIG. 2A and FIG. 2B each illustrate different configurations for a substrate device that is configured with VSD material having a composition such as described with any of the embodiments provided herein.

FIG. 3 is a simplified diagram of an electronic device on which VSD material in accordance with embodiments described herein may be provided.

### DETAILED DESCRIPTION

Embodiments described herein provide a composition of voltage switchable dielectric (VSD) material that comprises Boron. According to embodiments, VSD material is formulated that includes particle constituents that include one or more of Boron-nitride polymers, Boron nanotubes, and/or Boron nanoparticles. Still further, in some embodiments, the Boron particle constituents are doped with carbon.

Still further, some embodiments include a composition that includes a binder having multiple types particle constituents uniformly mixed therein. The multiple types of particle constituents include a concentration of conductor and/or semiconductor particle constituents, and a concentration of particles that include Boron. The composition is (i) dielectric in absence of a voltage that exceeds a characteristic voltage level, and (ii) conductive with application of a voltage that exceeds a characteristic voltage level of the composition.

Overview of VSD Material

As used herein, “voltage switchable material” or “VSD material” is any composition, or combination of compositions, that has a characteristic of being dielectric or non-conductive, unless a field or voltage is applied to the material that exceeds a characteristic level of the material, in which case the material becomes conductive. Thus, VSD material is a dielectric unless voltage (or field) exceeding the characteristic level (e.g. such as provided by ESD events) is applied to the material, in which case the VSD material is switched into a conductive state. VSD material can further be characterized as a nonlinear resistance material. With an embodiment such as described, the characteristic voltage may range in values that exceed the operational voltage levels of the circuit or device several times over. Such voltage levels may be of the order of transient conditions, such as produced by electrostatic discharge, although embodiments may include use of planned electrical events. Furthermore, one or more embodiments provide that in the absence of the voltage exceeding the characteristic voltage, the material behaves similar to the binder.

Still further, an embodiment provides that VSD material may be characterized as material comprising a binder mixed in part with conductor or semi-conductor particles. In the absence of voltage exceeding a characteristic voltage level, the material as a whole adapts the dielectric characteristic of the binder. With application of voltage exceeding the characteristic level, the material as a whole adapts conductive characteristics.

Many compositions of VSD material provide desired ‘voltage switchable’ electrical characteristics by dispersing a quantity of conductive materials in a polymer matrix to just below the percolation threshold, where the percolation threshold is defined statistically as the threshold by which a continuous conduction path is likely formed across a thickness of the material. Other materials, such as insulators or semiconductors, may be dispersed in the matrix to better control the percolation threshold.

Thus, VSD material compositions have a limit to which conductive particles can be added to maintain high off-state resistances. Moreover, after the VSD material has been pulsed with a high voltage event (e.g. ESD event, or simulated version thereof) some current must flow through the polymer matrix between the conductive particles. As a result, side reactions typically result which limits conduction and causes a hysteresis between the off state resistance before the high voltage event and after the high voltage event. This hysteresis is typically due to degradation of the polymer that results as a byproduct of conduction.

According to embodiments described herein, the constituents of VSD material may be uniformly mixed into a binder or polymer matrix. In one embodiment, the mixture is dispersed at nanoscale, meaning the particles that comprise the organic conductive/semi-conductive material are nano-scale in at least one dimension (e.g. cross-section) and a substantial number of the particles that comprise the overall dispersed quantity in the volume are individually separated (so as to not be agglomerated or compacted together).

Still further, an electronic device may be provided with VSD material in accordance with any of the embodiments described herein. Such electrical devices may include substrate devices, such as printed circuit boards, semiconductor packages, discrete devices, Light Emitting Diodes (LEDs), and radio-frequency (RF) components.

VSD Composite With Boron Material

In some applications, inherent issues may arise with the use of VSD composites that load particles to just below the percolation threshold. In particular, embodiments described herein recognize that some VSD compositions incorporate carbon nanotubes, conductive polymers, and other graphitic compounds. But in instances when these particles are loaded into a matrix of the composition to levels that are ‘just below’ percolation levels, the conductive nature of the particles can have higher than desired current leakage and/or very low loading levels. Other semiconductive particles or nanorods such as titanium dioxide, in oxide, or antimony doped in oxide are not as conductive and therefore can be loaded to high levels. However, these materials are not as conductive and therefore cannot conduct as much current in the “on state”; thereby not providing as much ESD protection. Hence, it is desirable to be able to “tune” the conductivity and bandgap of the polymer, particle, nanoparticle, and/or nanorods to optimize the balance between “on state” resistance and “off state” resistance, i.e. maximize off state resistance, and minimize on state resistance.

Still further, some embodiments described herein recognize that for many VSD composites, after a layer or quantity of the VSD material has been pulsed with a high voltage ESD event (or simulated version thereof), some current must flow through the polymer matrix between the conductive particles. As a result, degrading side reactions may arise, most likely due to the high electron flow and localized heating in the polymer.

Embodiments described herein include composites of VSD material that incorporate Boron particles in order to enhance desired electrical characteristics, such as reduction in leakage current. According to some embodiments, the Boron particles are in the form of Boron-nitride polymers, Boron nanotubes, and/or Boron nanoparticles. In some applications, Boron-nitride polymers, nanotubes, and nanoparticles (collectively referred to as “BN”) have some important advantages over, for example, carbon counterparts (e.g. carbon nanotubes) or other high aspect ratio particles (HAR particles such as nanowires or nanorods). Among these advantages, BN particles have excellent thermal stability, thermal conductivity, high electron mobilities, low dielectric constant, and versatility.

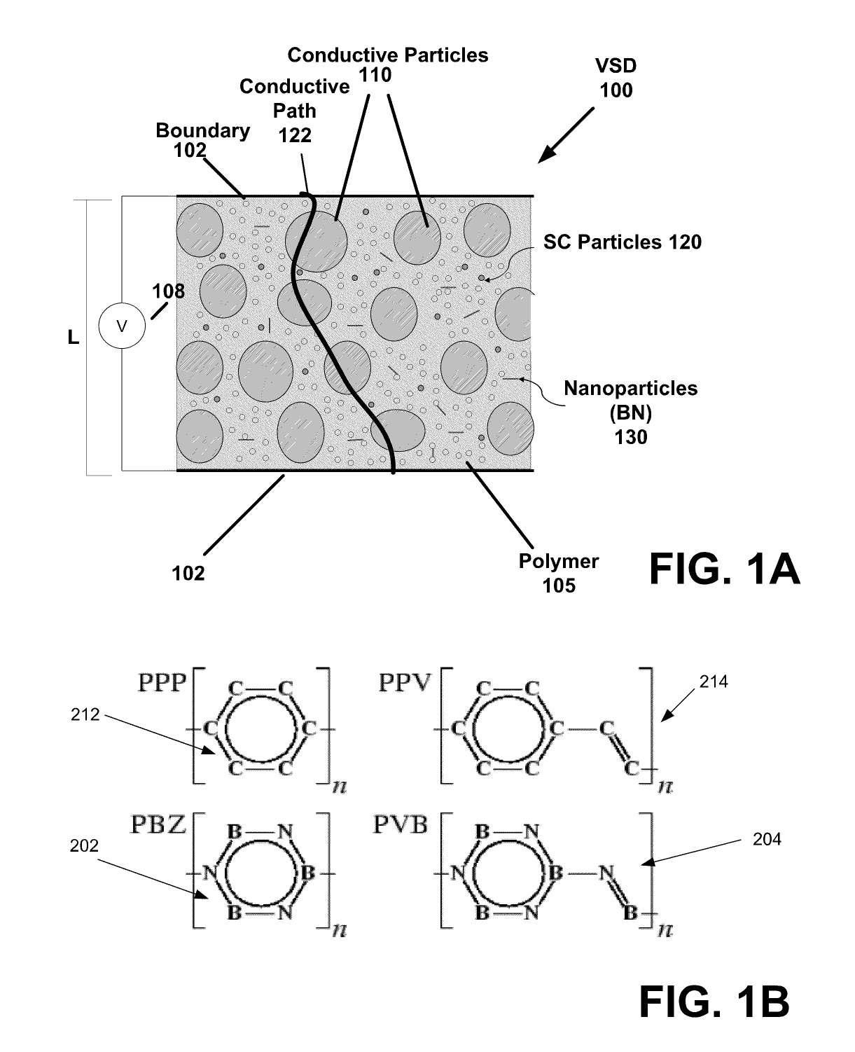

FIG. 1A is an illustrative (not to scale) sectional view of a layer or thickness of VSD material, depicting the constituents of VSD material in accordance with various embodiments. As depicted, VSD material 100 includes matrix binder 105 and various types of particle constituents, dispersed in the binder in various concentrations. The particle constituents of the VSD material may include conductive particles 110, semiconductor particles 120, and nano-dimensioned particles 130. It should be noted that the type of particle constituent that are included in the VSD composition may vary, depending on the desired electrical and physical characteristics of the VSD material. For example, some VSD compositions may include conductive particles 110, but not semiconductive particles 120 and/or nano-dimensioned particles 130. Still further, other embodiments may omit use of conductive particles 110.

Examples for matrix binder 105 include polyethylenes, silicones, acrylates, polymides, polyurethanes, epoxies, polyamides, polycarbonates, polysulfones, polyketones, and copolymers, and/or blends thereof.

Examples of conductive materials 110 include metals such as copper, aluminum, nickel, silver, gold, titanium, stainless steel, chrome, other metal alloys, or conductive ceramics like titanium diboride. Examples of semiconductive material 120 include both organic and inorganic semiconductors. Some inorganic semiconductors include, silicon carbide, Boron-nitride, aluminum nitride, nickel oxide, zinc oxide, zinc sulfide, bismuth oxide, titanium dioxide, cerium oxide, bismuth oxide, in oxide, indium in oxide, antimony in oxide, and iron oxide. The specific formulation and composition may be selected for mechanical and electrical properties that best suit the particular application of the VSD material. The nano-dimensioned particles 130 may be of one or more types. In one embodiment, at least one constituent that comprises a portion of the nano-dimensioned particles 130 are BN particles. Other nano-dimensioned particles may be included in the composition of VSD material. Such nano-dimensioned particles may have high-aspect ratios (HAR) and be one of (i) organic (e.g. carbon nanotubes, graphene) or (ii) inorganic (e.g. nano-wires or nanorods). The nano-dimensioned particles may be uniformly dispersed between the other particles at various concentrations. More specific examples of nano-dimensioned particles 130 may correspond to conductive or semi-conductive inorganic particles, such as provided by nanowires or certain types of nanorods. Material for such particles include copper, nickel, gold, silver, cobalt, zinc oxide, in oxide, silicon carbide, gallium arsenide, aluminum oxide, aluminum nitride, titanium dioxide, antimony, Boron-nitride, in oxide, indium in oxide, indium zinc oxide, bismuth oxide, cerium oxide, and antimony zinc oxide.

The dispersion of the various classes of particles in the matrix 105 may be such that the VSD material 100 is non-layered and uniform in its composition, while exhibiting electrical characteristics of voltage switchable dielectric material. Generally, the characteristic voltage of VSD material is measured at volts/length (e.g. per 5 mil), although other field measurements may be used as an alternative to voltage. Accordingly, a voltage 108 applied across the boundaries 102 of the VSD material layer may switch the VSD material 100 into a conductive state if the voltage exceeds the characteristic voltage for the gap distance L. In the conductive state, the matrix composite (comprising matrix binder 105 and particles constituents) conducts charge (as depicted by conductive path 122) between the conductive particles 110, from one boundary of VSD material to the other. One or more embodiments provide that VSD material has a characteristic voltage level that exceeds that of an operating circuit. As mentioned, other characteristic field measurements may be used. In application, the VSD material may be deposited to enable horizontal or vertical switching.

Specific compositions and techniques by which organic and/or HAR particles are incorporated into the composition of VSD material is described in U.S. patent application Ser. No. 11/829,946, entitled VOLTAGE SWITCHABLE DIELECTRIC MATERIAL HAVING CONDUCTIVE OR SEMI-CONDUCTIVE ORGANIC MATERIAL; and U.S. patent application Ser. No. 11/829,948, entitled VOLTAGE SWITCHABLE DIELECTRIC MATERIAL HAVING HIGH ASPECT RATIO PARTICLES; both of the aforementioned patent applications are incorporated by reference in their respective entirety by this application.

Some embodiments further enable VSD material to comprise particle constituents that are varistor particles. Embodiments may incorporate a concentration of particles that individually exhibit non-linear resistive properties, so as to be considered active varistor particles. Such particles typically comprise zinc oxide, titanium dioxide, Bismuth oxide, Indium oxide, in oxide, nickel oxide, copper oxide, silver oxide, Tungsten oxide, and/or antimony oxide. Such a concentration of varistor particles may be formed from sintering the varistor particles (e.g. zinc oxide) and then mixing the sintered particles into the VSD composition. In some applications, the varistor particle compounds are formed from a combination of major components and minor components, where the major components are zinc oxide or titanium dioxide, and the minor components or other metal oxides (such as listed above) that melt of diffuse to the grain boundary of the major component through a process such as sintering.

The particle loading level of VSD material using Boron compounds, as described by embodiments herein, may vary below or above the percolation threshold, depending on the electrical or physical characteristics desired from the VSD material. Particles with high bandgap (such as BN particles) may be used to enable the VSD composition to exceed the percolation threshold. Accordingly, in some embodiments, the total particle concentration of the VSD material, with the inclusion of a concentration of BN particles (such as described herein), is sufficient in quantity so that the particle concentration exceeds the percolation threshold of the composition. In particular, some embodiments provide that the concentration of BN particles may be varied in order to have the total particle constituency of the composition exceed the percolation threshold.

FIG. 1B illustrates examples of BN polymers, as well as their respective carbon based analogs, for inclusion as constituents in a composition of VSD material. The Boron compounds 202, 204 have corresponding carbon analogs 212, 214. One or more of the Boron compounds 202, 204 illustrated in FIG. 1B may comprise at least a portion of the nanoparticle constituents of VSD material, as described with an embodiment of FIG. 1A. Numerous other analogs may be utilized for creating alternative Boron compounds, including analogs to other elements or compounds.

As an addition or alternative, some embodiments provide for designing or tuning electrical or mechanical characteristics of VSD material by alternating the particle constituents. More specifically, some forms of BN are tunable with or without other particles in order to achieve desired results. According to one embodiment, a concentration of particles is developed for inclusion in a matrix of VSD material, where the concentration of particles includes BN particles that are tuned for desired electrical characteristics. In one embodiment, BN nanoparticles are “doped” by the introduction of carbon during the synthesis of the BN particles in order to enable a designer of VSD material to “tune” properties such as (i) electrical conduction, (ii) bandgap, (iii) current mobility, and (iv) resistivity. The use of BN nanoparticles in this manner would enable degradative side reactions (such as off-state leakage current) to be reduced in magnitude or quantity. Another advantage is that BN polymers can be more organic solvent soluble than their carbon analogs, making formulation of VSD material with Boron compounds much easier.

In still another embodiment, VSD composites may include a concentration of BN-silicone copolymers. BN-silicone copolymers have very high thermal stability and very low dielectric constant, which are desirable characteristics in some applications.

In some embodiments, Boron-nitride nanotubes can also be synthesized with carbon to form BCN networks. Boron-nitride nanotubes have been shown to be superior field emitters. In one embodiment, VSD compositions with superior thermal, electrical, and dielectric properties would result by combining Boron-nitride and/or Boron-carbon-nitride nanotubes with conductors and semiconductors in a polymer matrix. In another embodiment, borazine containing polymers and copolymers are combined with conductors and semiconductors (optionally BN containing semiconductors) to form a VSD material.

According to embodiments, VSD compositions may include, by percentage of volume, 5-99% binder, 0-70% conductor, 0-90% semiconductor, and BN material that has a volume of composition in a range of 0.01-95%. As mentioned, the BN material may include any of the material mentioned herein, including BN polymers, BN nanotubes, BN nanoparticles, borazine, and/or BCN networks. One or more embodiments provide for use of VSD material that includes, by percentage of volume, 20-80% binder, 10-50% conductor, 0%-70% semiconductor, and BN material having a volume that extends to just below percolation, or alternatively above the percolation threshold. Examples of binder materials, in addition to BN polymers, include silicone polymers, epoxy, polyimide, phenolic resins, polyethylene, polypropylene, polyphenylene oxide, polysulphone, solgel materials, ceramers, and inorganic polymers. Examples of conductive materials include metals such as copper, aluminum, nickel, silver, gold, titanium, stainless steel, chrome, and other metal alloys. Examples of semiconductive material include both organic and inorganic semiconductors. Some inorganic semiconductors include silicon, silicon carbide, Boron-nitride, aluminum nitride, nickel oxide, zinc oxide, zinc sulfide, bismuth oxide, and iron oxide. As described herein, the specific formulation and composition may be selected for mechanical and electrical properties that best suit the particular application of the VSD material.

VSD Material Applications

Numerous applications exist for compositions of VSD material in accordance with any of the embodiments described herein. In particular, embodiments provide for VSD material to be provided on substrate devices, such as printed circuit boards, semiconductor packages, discrete devices, thin film electronics, as well as more specific applications such as LEDs and radio-frequency devices (e.g. RFID tags). Still further, other applications may provide for use of VSD material such as described herein with a liquid crystal display, organic light emissive display, electrochromic display, electrophoretic display, or back plane driver for such devices. The purpose for including the VSD material may be to enhance handling of transient and overvoltage conditions, such as may arise with ESD events. Another application for VSD material includes metal deposition, as described in U.S. Pat. No. 6,797,145 to L. Kosowsky (which is hereby incorporated by reference in its entirety).

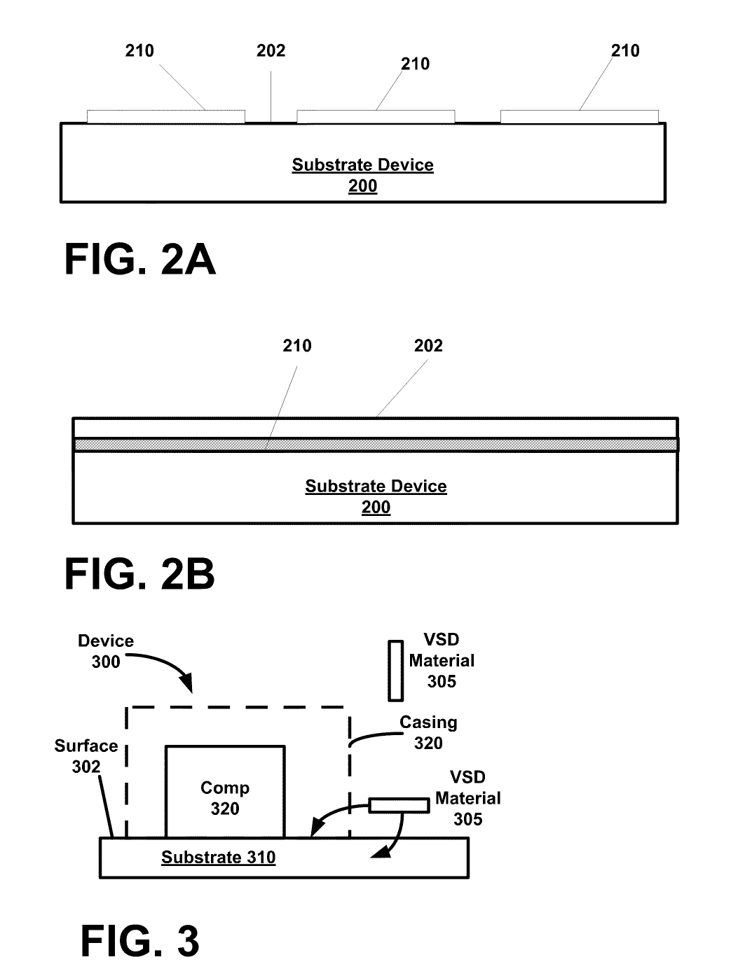

FIG. 2A and FIG. 2B each illustrate different configurations for a substrate device that is configured with VSD material having a composition such as described with any of the embodiments provided herein. In FIG. 2A, the substrate device 200 corresponds to, for example, a printed circuit board. In such a configuration, VSD material 210 (having a composition such as described with any of the embodiments described herein) may be provided on a surface 202 to ground a connected element. As an alternative or variation, FIG. 2B illustrates a configuration in which the VSD material forms a grounding path that is embedded within a thickness 210 of the substrate.

Electroplating

In addition to inclusion of the VSD material on devices for handling, for example, ESD events, one or more embodiments contemplate use of VSD material (using compositions such as described with any of the embodiments herein) to form substrate devices, including trace elements on substrates, and interconnect elements such as vias. U.S. patent application Ser. No. 11/881,896, filed on Sep. Jul. 29, 2007, and which claims benefit of priority to U.S. Pat. No. 6,797,145 (both of which are incorporated herein by reference in their respective entirety) recites numerous techniques for electroplating substrates, vias and other devices using VSD material. Embodiments described herein enable use of VSD material, as described with any of the embodiments in this application.

Other Applications

FIG. 3 is a simplified diagram of an electronic device on which VSD material in accordance with embodiments described herein may be provided. FIG. 3 illustrates a device 300 including substrate 310, component 320, and optionally casing or housing 330. VSD material 305 (in accordance with any of the embodiments described) may be incorporated into any one or more of many locations, including at a location on a surface 302, underneath the surface 302 (such as under its trace elements or under component 320), or within a thickness of substrate 310. Alternatively, the VSD material may be incorporated into the casing 330. In each case, the VSD material 305 may be incorporated so as to couple with conductive elements, such as trace leads, when voltage exceeding the characteristic voltage is present. Thus, the VSD material 305 is a conductive element in the presence of a specific voltage condition.

With respect to any of the applications described herein, device 300 may be a display device. For example, component 320 may correspond to an LED that illuminates from the substrate 310. The positioning and configuration of the VSD material 305 on substrate 310 may be selective to accommodate the electrical leads, terminals (i.e. input or outputs) and other conductive elements that are provided with, used by or incorporated into the light-emitting device. As an alternative, the VSD material may be incorporated between the positive and negative leads of the LED device, apart from a substrate. Still further, one or more embodiments provide for use of organic LEDs, in which case VSD material may be provided, for example, underneath an organic light-emitting diode (OLED).

With regard to LEDs and other light emitting devices, any of the embodiments described in U.S. patent application Ser. No. 11/562,289 (which is incorporated by reference herein) may be implemented with VSD material such as described with other embodiments of this application.

Alternatively, the device 300 may correspond to a wireless communication device, such as a radio-frequency identification device. With regard to wireless communication devices such as radio-frequency identification devices (RFID) and wireless communication components, VSD material may protect the component 320 from, for example, overcharge or ESD events. In such cases, component 320 may correspond to a chip or wireless communication component of the device. Alternatively, the use of VSD material 305 may protect other components from charge that may be caused by the component 320. For example, component 320 may correspond to a battery, and the VSD material 305 may be provided as a trace element on a surface of the substrate 310 to protect against voltage conditions that arise from a battery event. Any composition of VSD material in accordance with embodiments described herein may be implemented for use as VSD material for device and device configurations described in U.S. patent application Ser. No. 11/562,222 (incorporated by reference herein), which describes numerous implementations of wireless communication devices which incorporate VSD material.

As an alternative or variation, the component 320 may correspond to, for example, a discrete semiconductor device. The VSD material 305 may be integrated with the component, or positioned to electrically couple to the component in the presence of a voltage that switches the material on.

Still further, device 300 may correspond to a packaged device, or alternatively, a semiconductor package for receiving a substrate component. VSD material 305 may be combined with the casing 330 prior to substrate 310 or component 320 being included in the device.

Although illustrative embodiments have been described in detail herein with reference to the accompanying drawings, variations to specific embodiments and details are encompassed herein. It is intended that the scope of the invention is defined by the following claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A composition of voltage switchable dielectric (VSD) material comprising Boron material.

2. The composition of claim 1, wherein the Boron material comprises a concentration of nano-dimensioned Boron particles.

3. The composition of claim 1, wherein the Boron material includes Boron-nitride.

4. The composition of claim 1, wherein the Boron material includes Boron-nitride polymers.

5. The composition of claim 2, wherein the Boron material includes Boron-nitride nanotubes.

6. The composition of claim 1, wherein the VSD material further comprises a concentration of high-aspect ratio nano-particles other than Boron material.

7. The composition of claim 5, wherein the concentration of high-aspect ratio nano-particles include organic high-aspect ratio particles.

8. The composition of claim 5, wherein the concentration of high-aspect ratio nano-particles include metallic high-aspect ratio particles.

9. The composition of claim 1, wherein the Boron material includes a combination of Boron-nitride polymers, Boron nanoparticles, and/or Boron nanorods.

11. The composition of claim 1, further comprising a concentration of particles that exceeds a percolation threshold of the VSD composition.

12. The composition of claim 1, further comprising a concentration of varistor particles.

13. A method for forming a composition of voltage switchable dielectric (VSD) material, the method comprising:
selecting particle constituents for the composition, wherein at least some of the particle constituents include Boron;
uniformly mixing the particle constituents in a binder.

14. The method of claim 13, wherein the Boron particle constituents correspond to one or more of Boron-nitride polymers, Boron nanotubes, and/or Boron nanoparticles.

15. The method of claim 14, further comprising adjusting an electrical characteristic of the VSD material by doping the Boron particle constituents with carbon.

16. A composition comprising:
a binder;
multiple types of particle constituents, including a concentration of conductor and/or semiconductor particle constituents, and a concentration of particles that include Boron; and
wherein said composition is (i) dielectric in absence of a voltage that exceeds a characteristic voltage level, and (ii) conductive with application of a voltage that exceeds a characteristic voltage level of the composition.

17. The composition of claim 16, wherein the binder is a polymer.

18. The composition of claim 16, wherein the multiple types of particle constituents are mixed so that the composition is non-layered.

19. The composition of claim 16, wherein the concentration of particles that include Boron include nano-dimensioned Boron particles.

20. The composition of claim 13, wherein the concentration of particles that include Boron-nitride.

21. The composition of claim 13, wherein the particle constituents exceed a percolation threshold of the composition.

22. The composition of claim 13, wherein the multiple types of particle constituents include a concentration of varistor particles.

23. The composition of claim 13, wherein the concentration of particles that include Boron further include Boron-nitride polymers.

24. The composition of claim 13, wherein the concentration of particles that include Boron further include Boron-nitride nanotubes.
